(19) United States
(12) Patent Application Publication
(10) Pub. No.: US 2018/0217247 A1
(43) Pub. Date: Aug. 2, 2018

(54) A Proximity Detector

(71) Applicant: THOMSON LICENSING, Issy les Moulineaux (FR)

(72) Inventor: Paul G. KNUTSON, Westfield, IN (US)

(21) Appl. No.: 15/748,009

(22) PCT Filed: Aug. 10, 2016
(86) PCT No.: PCT/US2016/046286

§ 371 Date: Jan. 26, 2018

Related U.S. Application Data
(60) Provisional application No. 62/205,933, filed on Aug. 17, 2015.

(51) Int. Cl. G01S 13/04; G06F 1/32

(52) U.S. Cl. CPC G01S 13/04; H04W 84/12; G06F 1/3206

(57) ABSTRACT

A proximity detector includes a transmitting antenna producing, in accordance with a first radio frequency (RF) signal, an electro-magnetic field. A receiving antenna produces a first component of a second RF signal from an unscattered portion of the electro-magnetic field and produces a second component of the second RF signal from a scattered portion of the electro-magnetic field that is scattered by a user body exposed to the electro-magnetic field. The receiving antenna has an axis that is oriented perpendicularly with respect to an axis of the transmitting antenna in a manner to increase a ratio between a magnitude of the second component and a magnitude of the first component. A signal processor generates a proximity detection indicative signal when a change in the second component is indicative of a change in position of the electro-magnetic field scattering body. The proximity detection indicative signal automatically initiates a “wake-up” process in, for example, a tablet.

### CROSS REFERENCE TO RELATED APPLICATION

This application claims priority under 35 U.S.C. 119(e) to U.S. Provisional Patent Application Ser. No. 62/205933 filed on Aug. 17, 2015 and titled “A PROXIMITY DETECTOR”. The provisional application is expressly incorporated by reference herein in its entirety for all purposes.

### TECHNICAL FIELD

The present disclosure is directed to a proximity detector using a radio frequency (RF) signal.

### BACKGROUND

A mobile device, also known as a handheld device, handheld computer or simply handheld, may be a pocket-sized computing device, typically having a display screen with touch input and/or a miniature keyboard. One type of such mobile device is a Smartphone. A smartphone may be defined as device that lets you make telephone calls, but also adds features that you might find on a personal digital assistant or a computer. A smartphone also offers the ability to send and receive e-mail and edit Office documents, for example. Another mobile device may be referred to as a tablet computer or simply tablet. A tablet is a complete personal mobile computer, larger than a mobile phone, integrated into a flat touch screen and primarily operated by touching the screen. It often uses an onscreen virtual keyboard or a digital pen rather than a physical keyboard.

The display of a mobile device or of a personal computer (PC) has the highest power consumption element of an idling device. It may run between 30-50 percent of the total system idle power. Aggressively turning off the display power can significantly increase the battery life of the device. One approach is a user's customized timer threshold to turn off the display when the device is not receiving any input, keyboard or mouse, to operate in a so-called “sleep mode”. The timer is typically between 1 to 10 minutes. Low-end setting of the timer is annoying when viewing documents and high-end setting reduces power saving opportunity. Determining if a user appears in proximity to the device and therefore is likely to use the device would be advantageous. When a user is detected to be present in proximity to the device, the device is triggered to turn on, referred to a so-called “wake-up” mode.

U.S. Pat. No. 8,774,145, Lin, et al., suggests using proximity detection that provides a low power user presence detection mechanism and with it a way to turn on/off the display. It suggests waking up host PC by proximity.

### SUMMARY

A proximity detector according to a first aspect of the present disclosure includes a source of a first radio frequency (RF) signal and a transmitting antenna. A transmitter output stage is responsive to the first RF signal and coupled to the transmitting antenna for producing, in accordance with the first RF signal, an electro-magnetic field. A receiving antenna that is substantially orthogonally oriented relative to the transmitting antenna captures a received RF signal produced from scattered reflections of the electro-magnetic field produced by the transmitting antenna such that a change in position of an electro-magnetic field scattering body produces a change in the received RF signal. A signal processor is responsive to the received RF signal for generating a proximity detection indicative signal when the change in the received RF signal is detected.

According to a second aspect of the present disclosure a method for detecting a change in position of an electro-magnetic field scattering body is suggested. The method comprises generating a first radio frequency (RF) signal, applying the first RF signal to a transmitting antenna to generate an electro-magnetic field, receiving in a receiving antenna that is substantially orthogonally oriented relative to said transmitting antenna a received RF signal produced from scattered reflections of the electro-magnetic field produced by the transmitting antenna such that a change in position of an electro-magnetic field scattering body produces a corresponding change in the received RF signal, and generating a proximity detection indicative signal when the change in the received RF signal produced by the change in position of the electro-magnetic field scattering body is detected.

### BRIEF DESCRIPTION OF THE DRAWINGS

FIGS. 1A and 1B illustrate an advantageous proximity detector; and

FIG. 2 illustrates an advantageous flow diagaram associated with the proximity detector of FIGS. 1A and 1B.

### DETAILED DESCRIPTION

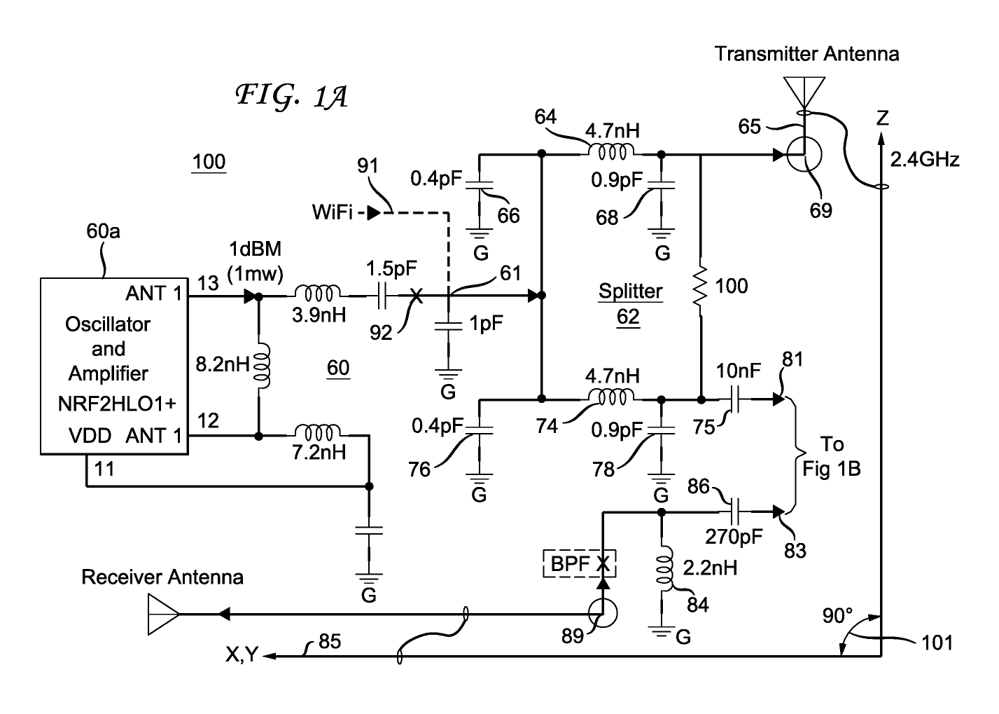

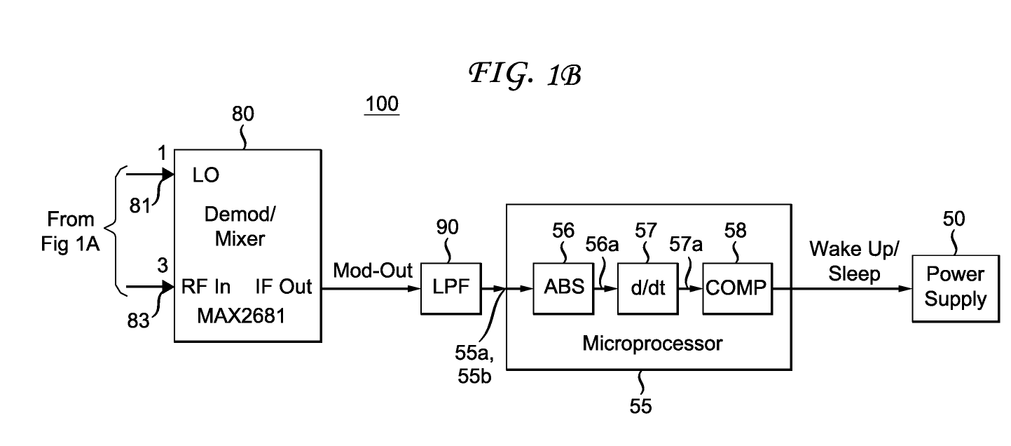

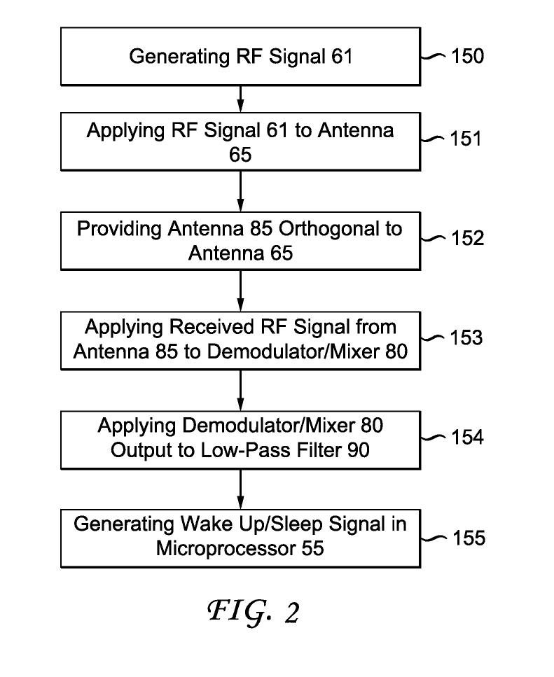

FIGS. 1A and 1B illustrate corresponding portions of an advantageous proximity detector 100 for providing proximity detection information for controlling power consumption in, for example, a tablet, not shown. FIG. 2 illustrates a flow diagaram associated with the proximity detector of FIGS. 1A and 1B. Similar symbols and numerals in FIGS. 1A, 1B and 2 indicate similar items or functions.

A conventional radio frequency (RF) signal source 60 of FIG. 1A generates an RF signal 61, as shown in block 150 of FIG. 2. RF signal source 60 of FIG. 1A includes an oscillator and an amplifier (oscillator/amplifier) 60a having an output stage, not shown, forming an integrated circuit. Some components that are included in conventional RF signal source 60 are shown but not identified by reference numerals and some have been altogether omitted for simplifying the figure.

RF signal 61 may be at a frequency selected from the unlicensed industrial, scientific and medical (ISM) radio bands, for example, 2.4 GHz and at 1 mW power. Because proximity detector 100 uses the ISM bands, it might need to tolerate any interference from other ISM equipment. One proposed way of attaining such tolerance is accomplished by dynamically monitoring any presently used frequency and then dynamically selecting the transmitted frequency and/or the time slot used by proximity detector 100 for transmission in a manner to avoid conflict with other ISM devices.

As an advantageous alternative to RF signal source 60, a Wi-Fi signal that is typically already produced in such tablet may be used for generating RF signal 61. This alternative is indicated by a broken line 91 connection and a cut 92.

RF signal 61 is coupled via an inductor 64 of a conventional RF splitter 62 to an input connector 69 of a transmitter or transmitting antenna 65 for producing an electro-magnetic field that is radiated from antenna 65, as shown in block 151 of FIG. 2. Splitter 62 of FIG. 1A includes a first capacitor 66 and a second capacitor 68 having, each, a terminal that is coupled to a common conductor or ground G. A first end terminal and a second end terminal of capacitors 66 and 68 are coupled to end terminals, respectively, of inductor 64 to form an inverted U-shaped network.

RF signal 61 having a constant amplitude and phase is also coupled via an inductor 74 of splitter 62 and via a coupling capacitor 75 that is coupled in series with inductor 74 to an input 81 of a conventional demodulator/mixer 80 of FIG. 1B. Splitter 62 FIG. 1A additionally includes a first capacitor 76 and a second capacitor 78 that are coupled, each, to ground G. A first end terminal and a second end terminal of capacitors 76 and 78 are coupled to end terminals, respectively, of inductor 74 to form an inverted U-shaped network.

An output connector 89 of a receiver antenna 85 that is orthogonal to antenna 65, as shown in block 152 of FIG. 2, is coupled via a coupling capacitor 86 of FIG. 2 to an input 83 of a demodulator/mixer 80 of FIG. 1A. An inductor 84 of FIG. 1A is coupled between ground G and output connector 89 of receiver antenna 85. A high frequency RF electro-magnetic field in, for example, the ISM band is produced by transmitting antenna 65. This RF electro-magnetic field will be picked up in receiver or receiving antenna 85 and a resulting RF signal will be developed at input 83 of demodulator/mixer 80 of FIG. 1B, as shown in block 153 of FIG. 2.

The RF signal that is developed at input 83 of demodulator/mixer 80 of FIG. 1B is representative of the magnitude of the RF signal received in antenna 85 of FIG. 1A. The reference RF signal that is developed at input 81 of FIG. 1B having a constant amplitude and the RF signal that is applied to input 83 of demodulator/mixer 80 are processed or “mixed” in demodulator/mixer 80. An output signal MOD-OUT of demodulator/mixer 80 is coupled via a low-pass filter 90 to produce an input signal 55b developed at an input terminal 55a of a microporocessor 55, as shown in block 154 of FIG. 2. Low-pass filter 90 of FIG. 1B removes signal components at high frequency including the high frequency of RF signal 61 and its harmonics from input signal 55b. On the other hand, low frequency signal components that are contained in input signal 55b are not removed. As explained later on, the slowly changing or low frequency signal components that are contained in input signal 55b are indicative of changes in amplitude and phase of the received RF signal in antenna 85 of FIG. 1A that is applied to input 83 of demodulator/mixer 80 of FIG. 1B. The low frequency signal components that are contained in input signal 55b are indicative of a change in position or movement of, for example, a body or a part of the body of a user that is in the vicinity of antenna 85 of FIG. 1A.

Low-pass filtered input signal 55b of FIG. 1B is further processed using a program executed in microprocessor 55. Initially, input signal 55b is processed by obtaining an absolute value of the magnitude of input signal 55b schematically represented by a box 56, drawn inside the block of microprocessor 55, to produce an output signal 56a measuring the magnitude of signal 55b. Output signal 56a produced in box 56 is processed by a differentiating process that differentiates signal 56a, a process which is represented schematically by a box 57, drawn inside the block of microprocessor 55. A resulting output signal 57a of differentiating process schematically represented by box 57 is indicative of the extent by which the magnitude of low pass filtered signal 55a changes in time. As explained later on, output signal 57a of differentiating box 57 is indicative of change in position or movement of, for example, a body or a part of the body of a user that is in the vicinity of antenna 85 of FIG. 1A.

Resulting output signal 57a of differentiating box 57 is compared in a comparison process schematically represented by a box 58, shown inside the block of microprocessor 55. There, it is determined whether output signal 57a produced in differentiating box 57 exceeds a predetermined threshold. If output signal 57a produced in differentiating box 57 exceeds the predetermined threshold, microprocessor 55 generates a control signal WAKE-UP/ SLEEP, as shown in block 155 of FIG. 2, at a first logic state for selectively turning on a power supply 50 of FIG. 1B of, for example, a mobile device, not shown in details, to change a mode of operation from a standby mode to a run mode operation. Changes in the received RF signal in antenna 85 are indicative of corresponding changes in the position of the body in the vicinity of the mobile device such as a tablet. These changes are, advantageously, used by proximity detector 100 to initiate a program interrupt in microprocessor 55 of FIG. 1B referred to as “wake up”. Consequently, microprocessor 55 of, for example, a tablet, not shown, produces signal WAKE-UP/ SLEEP that causes a power supply 50 to change its mode of operation from the standby mode operation to the run mode operation. This change of mode operation occurs in advance of and without any actual user input. The generation of signal WAKE-UP/ SLEEP provides advance notice to the tablet that a user is near for enabling the tablet to prepare its user interface in advance of the user actually touching the tablet.

Microprocessor 55 generates control signal WAKE-UP/ SLEEP at a second logic state for selectively turning off power supply 50 to operate in the standby mode operation in the absence of user activation of the mobile device or in the absence of movement detection by proximity detector 100, during an interval that exceeds a predetermined length of time. Standby mode operation can also occur when the user actively turns off the mobile device.

When the body, for example, of a potential user of the mobile device moves in the vicinity of receiver antenna 85 of FIG. 1A of the mobile device, it will cause a change in magnitude of the RF signal received in receiver antenna 85 and developed at input 83 of demodulator/mixer 80 of FIG. 1B. Such potential user movement, not shown, will cause, peaks and nulls of the RF electro-magnetic field to change location, sometimes strengthening the RF signal developed on receiver antenna 85 of FIG. 1A and sometimes weakening the received RF signal on receiver antenna 85.

A first component, not shown, of the RF signal developed at input 83 of demodulator/mixer 80 of FIG. 1B is produced from an unscattered portion, not shown, of the electro-magnetic field radiated from antenna 65 of FIG. 1A. On the other hand, a second component, not shown, of the RF signal developed at input 83 is produced from a scattered portion of the electro-magnetic field caused by a body, not shown, exposed to the electro-magnetic field. It may be desirable to increase a ratio between a magnitude of the second component, not shown, of the RF signal developed at input 83 and the first component, not shown, of the RF signal developed at input 83. This feature is advantageous because the direct or unscattered path from the transmitt antenna 65 to receiver antenna 85 that produces the first component does not contain movement related information but might, disadvantageously, tend to swamp out the smaller changes caused by reflections and absorption of the nearby scatterers (i.e. the person approaching the tablet). Antenna 65 of FIG. 1A is oriented in a direction “Z”, that is an arbitrary or reference direction which may vary by, for example, a user tilting of the mobile device, not shown.

In an advantageous arrangement, antenna 85 is oriented in a direction “X” or “Y” to indicate that antenna 65 and antenna 85 are oriented at an angle 101 that is, preferably, 90 degrees or orthogonal to each other. By disposing axis “Z” of transmitting antenna 65 in an angular direction such as 90 degrees with respect to axis “X” or “Y” of receiving antenna 85, the ratio between a magnitude of the second component of the RF signal in antenna 85, that is produced by the scattering electro-magnetic fields, and a magnitude of the first component of the RF signal in antenna 85, that is produced by unscattering electro-magnetic field, is, advantageously, increased. This feature was found to increase the ratio between the received scattered signal to the received direct signal developed in antenna 85 by at least 10 dB.

1. (canceled)

2. (canceled)

3. (canceled)

4. (canceled)

5. (canceled)

6. (canceled)

7. (canceled)

8. (canceled)

9. (canceled)

10. (canceled)

11. Apparatus comprising:
an antenna orthogonally oriented relative to a transmitting antenna to capture a received radio frequency (RF) signal produced from scattered reflections of an electro-magnetic field produced by transmission of a first RF signal via the transmitting antenna such that a change in position of an electro-magnetic field scattering body produces a change in the received RF signal; and
a signal processor generating a proximity detection indicative signal based on the change in the received RF signal being detected.

12. The apparatus of claim 11 further comprising:
a source of the first RF signal;
a transmitting antenna;
a transmitter output stage responsive to the first RF signal and coupled to the transmitting antenna to produce, in accordance with the first RF signal, the electro-magnetic field.

13. The apparatus of claim 11 wherein the proximity detection indicative signal is applied to a power supply of an electronic device to change a mode of operation of the power supply from a standby mode to a run mode of operation.

14. The apparatus of claim 11 wherein the apparatus is included in a mobile device having a WiFi communication capability and wherein the first RF signal additionally provides the WiFi communication capability.

15. The apparatus of claim 13 wherein the signal processor comprises a demodulator responsive to the received RF signal and to the first RF signal to generate a demodulated signal.

16. The apparatus of claim 15 wherein the demodulated signal is coupled to a stage that produces an output signal indicative of a magnitude of the demodulated signal and wherein the output signal of the stage is coupled to a comparator that generates the proximity detection indicative signal when a rate of change of the output signal of the stage exceeds a threshold value.

17. A proximity detector, comprising:
a source of a first radio frequency (RF) signal;
a transmitting antenna;
a transmitter output stage responsive to the first RF signal and coupled to the transmitting antenna to produce, in accordance with the first RF signal, an electro-magnetic field;
a receiving antenna orthogonally oriented relative to the transmitting antenna to capture a received RF signal produced from scattered reflections of the electro-magnetic field produced by the transmitting antenna such that a change in position of an electro-magnetic field scattering body produces a change in the received RF signal; and
a signal processor responsive to the received RF signal to generate a proximity detection indicative signal when the change in the received RF signal is detected.

18. A proximity detector according to claim 17 wherein the proximity detection indicative signal is applied to a power supply of an electronic device to change a mode of operation of the power supply from a standby mode to a run mode operation.

19. A proximity detector according to claim 17 wherein the proximity detector is included in a mobile device having a WiFi communication capability and wherein the first RF signal additionally provides the WiFi communication capability.

20. A proximity detector according to claim 17 wherein the signal processor comprises a demodulator responsive to the received RF signal and to the first RF signal to generate a demodulated signal.

21. A proximity detector according to claim 20 wherein the demodulated signal is coupled to a stage that produces an output signal indicative of a magnitude of the demodulated signal and wherein the output signal of the stage is coupled to a comparator that generates the proximity detection indicative signal when a rate of change of the output signal of the stage exceeds a threshold value.

22. A method comprising:
receiving via an antenna orthogonally oriented relative to a transmitting antenna a received radio frequency (RF) signal produced from scattered reflections of an electro-magnetic field produced by transmission of a first RF signal via the transmitting antenna such that a change in position of an electro-magnetic field scattering body produces a change in the received RF signal;
detecting the change in the received RF signal; and
generating a proximity detection indicative signal based on the detecting of the change in the received RF signal.

23. The method of claim 22 further comprising:
applying the proximity detection indicative signal to a power supply of an electronic device; and
changing a mode of operation of the power supply from a standby mode to a run mode of operation in response to the proximity detection indicative signal.

24. The method of claim 22 wherein the detecting comprises:
generating a demodulated signal responsive to the received RF signal and to the first RF signal.

25. The method of claim 24 further comprising:
producing an output signal indicative of a magnitude of the demodulated signal; and wherein the step of generating the proximity detection indicative signal comprises comparing the output signal to a value representing a rate of change of the output signal.

26. The method of claim 25 further comprising:
providing a WiFi communication capability in a mobile device using the first RF signal.

27. A method to detect a change in position of an electro-magnetic field scattering body, comprising:
generating a first radio frequency (RF) signal;
applying the first RF signal to a transmitting antenna to generate an electro-magnetic field;
receiving in a receiving antenna that is orthogonally oriented relative to the transmitting antenna a received RF signal produced from scattered reflections of the electro-magnetic field produced by the transmitting antenna such that a change in position of an electro-magnetic field scattering body produces a corresponding change in the received RF signal; and
detecting the change in the received RF signal produced by the change in position of the electro-magnetic field scattering body; and
generating a proximity detection indicative signal in response to detecting the change.

28. The method of claim 27 further comprising:
applying the proximity detection indicative signal to a power supply of an electronic device; and
changing a mode of operation of the power supply from a standby mode to a run mode operation in response to the proximity detection indicative signal.

29. The method of claim 28 wherein
the detecting comprises generating a demodulated signal responsive to the received RF signal and to the first RF signal; and further comprising
producing an output signal indicative of a magnitude of the demodulated signal wherein the generating of the proximity detection indicative signal comprises comparing the output signal to a value representing a rate of change of the output signal.

30. The method of claim 29 further comprising:
providing a WiFi communication capability in a mobile device using the first RF signal.
